(19) United States
(12) Patent Application Publication
(10) Pub. No.: US 2020/0151290 A1
(43) Pub. Date: May 14, 2020

(54) METHOD OF ENCODING A 3D SHAPE INTO A 2D SURFACE

(71) Applicants: ECOLE POLYTECHNIQUE FEDERALE DE LAUSANNE (EPFL), Lausanne (CH); CARNEGIE MELLON UNIVERSITY, Pittsburgh, PA (US)

(72) Inventors: Mina KONAKOVIC-LUKOVIC, Lausanne (CH); Keenan CRANE, Pittsburgh, PA (US); Mark PAULY, Lausanne (CH); Julian PANETTA, Échandens (CH)

(73) Assignees: ECOLE POLYTECHNIQUE FEDERALE DE LAUSANNE (EPFL), Lausanne (CH); CARNEGIE MELLON UNIVERSITY, Pittsburgh, PA (US)

(21) Appl. No.: 16/186,901

(22) Filed: Nov. 12, 2018

(51) Int. Cl. G06F 17/50

(52) U.S. Cl. CPC G06F 17/5009

(57) ABSTRACT

The present invention concerns a method for encoding a given 3D shape into a target 2D linkage. The method comprises: (a) providing an initial 2D surface; and (b) defining on the initial 2D surface an auxetic pattern of geometric elements planarly linked between them to obtain the target 2D linkage, the pattern allowing the target 2D linkage to be virtually stretched. The target 2D linkage has a spatially varying scale factor thereby spatially varying the stretching capability of the 2D linkage.

### TECHNICAL FIELD

The present invention belongs to the fields of differential geometry, geometric modeling and computer-aided design and manufacturing. More specifically, the invention relates to a method of encoding a curved 3D shape into a 2D surface by using auxetic patterning. The invention equally relates to deployable structures obtainable by carrying out the method.

### BACKGROUND OF THE INVENTION

Deployable structures are shape-shifting mechanisms that can transition between two or more geometric configurations. Often conceived to minimize space requirements for storage or transport, nowadays such structures enable industrial, scientific and consumer applications at a wide variety of scales. Deployable structures are used, for example, for antennas or solar panels in satellites, as coronary stents in medical applications, as consumer products (e.g. umbrellas), or in architectural designs (e.g. retractable bridges or relocatable, temporary event spaces).

Most existing implementations of deployable structures are geometrically simple and often exhibit strong symmetries. Deploying more general curved surfaces is made difficult by the inherent complexity of jointly designing initial and target geometries within the constraints imposed by the deployment mechanism.

Several previous works have designed custom materials to achieve high-level deformation goals. Some solutions stack layers of various nonlinear base materials to produce a desired force-displacement curve. Microstructure design works construct small-scale structures from one or two printing materials to emulate a large space of linearly elastic materials. These works focus on designing deformable materials that typically undergo small stretches and return to their rest configurations when unloaded, making them less suitable as deployment mechanisms.

Another common goal is to optimize deformable objects' rest shapes so that they assume desired equilibrium shapes under load. The known inverse elastic shape design algorithms typically design flexible objects achieving specified poses under gravity or user-defined forces. The deformations involved are generally small, and these works do not attempt to find compact rest configurations amenable to efficient fabrication, transport, and deployment. Other works have focused on designing objects that rapidly expand into nearly rigid target shapes. For instance, it is known how to construct inflatable structures by fusing together sheets of nearly inextensible material. Because each panel inflates into a nearly developable surface, many small panels are potentially needed to closely approximate a smooth, wrinkle-free doubly-curved surface.

In the field of actuated form-prescribed geometry, solutions have been proposed which aim to encode a three-dimensional (3D) target surface in a flat sheet of material. In these methods, the activation mechanism is directly integrated into the material in the form of a pre-tensioned elastic membrane. Upon release, the membrane contracts and forces the pre-shaped rigid elements into their global target configuration. This approach achieves relatively good results, but has several drawbacks: (i) pre-stretched materials are limited in scale; (ii) fabrication is complex, since it requires compositing multiple materials and the rigid parts cannot e.g. simply be laser cut; (iii) shaping by contraction means that the flat surface is larger in area than the target surface, reducing potential packing benefits; (iv) closed surfaces are more difficult to realize (only disk-topology surfaces have been demonstrated).

Auxetic surface materials and linkages permit otherwise inextensible flat sheets of material to uniformly stretch as needed to deform into doubly curved surfaces. Design tools have been proposed for fabricating curved target surfaces by cutting auxetic patterns into flat sheets. However, the resulting uniform linkage pattern is difficult to deploy because the target surface is not singled out in any way; the structure can just as easily deform into an infinite family of other surfaces. This ambiguity necessitates the use of guide surfaces and careful manual alignment when shaping the material.

### SUMMARY OF THE INVENTION

The present invention, as described hereinafter and in the appended claims, seeks to overcome at least some of the drawbacks of the prior approaches as described above.

According to a first aspect of the invention, there is provided a method of encoding a given 3D shape into a 2D surface as recited in claim 1.

As explained later in more detail, the proposed solution has the advantage that during deployment, no support structure, such as a scaffolding, is needed. Furthermore, various shapes may easily be obtained.

According to a second aspect of the invention, there is provided a deployable 3D structure obtainable by the encoding method of the present invention.

According to a third aspect of the invention, there is provided a data processing unit configured to carry out the encoding method of the present invention.

Other aspects of the invention are recited in the dependent claims attached hereto.

### BRIEF DESCRIPTION OF THE DRAWINGS

Other features and advantages of the invention will become apparent from the following description of a non-limiting example embodiment, with reference to the appended drawings, in which:

FIGS. 1a to 1d show triangle configurations in their initial and final states, thereby illustrating how different initial states can be expanded to reach their final states;

FIG. 2 shows a 2D triangle structure in its initial, partially expanded configuration according to an example of the present invention;

FIG. 3 shows the triangle configuration of FIG. 2 but in its final, fully expanded deployed state according to an example of the present invention;

FIG. 4 is a flow chart illustrating a process of encoding a target 3D structure into a target 2D structure according to an example of the present invention;

FIGS. 5a to 5h show different 2D or 3D structures at different stages of the process of FIG. 4;

FIG. 6 illustrates a substructure of FIG. 5f showing a hexagonal opening in the fully expanded state of the structure;

FIG. 7 illustrates the concept of cone singularities which may be used to bring conformal scale factors within an admissible range;

FIG. 8 illustrates the concept of in-plane opening, which may be used to reduce material stresses by preopening a given linkage as much as possible prior to inflation for instance; and

FIG. 9 illustrates the concept of filling in a surface to obtain a surface devoid of holes.

### DETAILED DESCRIPTION OF AN EMBODIMENT OF THE INVENTION

The subject matter herein described will be clarified in the following by means of the following description of those aspects which are depicted in the drawings. It is however to be understood that the subject matter described in this specification is not limited to the aspects described below and depicted in the drawings; to the contrary, the scope of the subject matter herein described is defined by the claims. Moreover, it is to be understood that the specific conditions or parameters described and/or shown in the following do not limit the subject matter herein described, and that the terminology used herein is for the purpose of describing particular aspects by way of examples only and is not intended to be limiting. Identical or corresponding functional and structural elements which appear in the different drawings are assigned the same reference numerals.

Unless defined otherwise, technical and scientific terms used herein have the same meaning as commonly understood by a skilled person in the field. Furthermore, unless otherwise required by the context, singular terms shall include pluralities and plural terms shall include the singular. Some of the techniques of the present description are generally performed according to conventional methods well known in the art and as described in various general and more specific references that are cited and discussed throughout the present description.

As used in the following and in the appended claims, the singular forms “a”, “an” and “the” include plural referents unless the context clearly dictates otherwise. Also, the use of “or” means “and/or” unless stated otherwise. Similarly, “comprise”, “comprises”, “comprising”, “include”, “includes” and “including” are interchangeable and not intended to be limiting. It is to be further understood that where, for the description of various embodiments, use is made of the term “comprising”, those skilled in the art will understand that in some specific instances, an embodiment can be alternatively described using language “consisting essentially of” or “consisting of.”

The following description will be better understood by means of the following definitions. As used herein, the expression “encoding a 3D shape into a target 2D surface or linkage” has the meaning of providing a code of information based on geometrical rules that, upon deciphering, allows conversion of said information into a geometrical shape. Particularly, in the encoding method of the present invention, the code of information is provided by pattern(s) of geometric elements set on a substantially planar (2D) surface. The geometric elements are connected via links, and more specifically 2D links, in such a way to implicitly fix a curvature of a target shape upon providing a suitable actuation “trigger”. As it will be evident to a person skilled in the art, a method for encoding according to the invention is typically a modeling process, which is preferably implemented via computer graphics tools on virtual 2D surfaces. These tools aim to determine and optimize the above-mentioned patterns. Therefore, the encoding steps allow a substantially two-dimensional shape to be virtually stretched, the “actuation trigger” being in this case a simulation of a stretch on the patterned surface. Nonetheless, as will be detailed later in the present description, the encoding method according to the present invention permits to suitably determine patterns of geometric elements on real 2D surfaces, thereby allowing these elements or surfaces to be stretched to obtain target 3D shapes.

The expression “auxetic pattern” refers to a geometrical configuration, model or scheme by which geometrical elements are arranged on a surface in such a way that the surface as a whole or at least its portions behave as an auxetic material. The expression “auxetic material” refers to a material or a structure having a negative Poisson's ratio. Under uniaxial compression (or tension), auxetic materials contract (or expand) transversely (for instance, when stretched they become thicker perpendicular to the applied force). In the embodiment described below, the individual geometric elements when taken in isolation do not behave as auxetic elements. These individual elements are not arranged to be stretched or compressed, i.e. their size remains constant during the deployment process as explained below.

As used herein, a scale factor is a number which scales, or multiplies, a dimension-related parameter, which may be an area or a side length. Thus, the scale factor may be understood to be the ratio between a given area in the fully expanded state and the corresponding area in the non-expanded state. In one example, the scale factor is the ratio between the areas of two or more, preferably a plurality of, geometrical elements in the expanded state and the same elements in the non-expanded state. The present invention relies on the concept of a spatially varying scale factor. This means that the scale factor varies along the surface. For example, a first set of geometric elements has a first scale factor, while a second, different set of geometric elements has a second, different scale factor.

A linkage is understood to mean a surface comprising a set of geometric elements connected by joints or links, advantageously rotational links. A linkage may be a 2D or a 3D surface. In other words, a linkage, or more specifically a mechanical linkage is an assembly of bodies (geometric elements) connected to manage forces and movement.

A “doubly curved 3D shape” is a 3D shape comprising a doubly curved surface. A “doubly curved surface”, also referred to herein as a “non-developable surface”, is a surface having a non-zero Gaussian curvature at given points. A doubly curved surface is a surface that cannot be flattened onto a plane without distortion (i.e. stretching or compressing). Conversely, a “singly curved surface”, also referred to herein as a “developable surface”, is a surface which can be made by transforming a plane (i.e. by folding, bending, rolling, cutting and/or gluing) without stretching or tearing, that is, it can be developed or unrolled isometrically onto a plane, having the same Gaussian curvature at given points.

According to one aspect of the invention, a method for encoding a curved 3D shape into a target 2D linkage surface is provided. The method comprises a first step of providing an initial or starting 2D surface and subsequently defining on the 2D surface an auxetic pattern of geometric elements planarly linked between them. Upon definition of an auxetic pattern on the 2D surface, the said 2D surface acquires the ability to be virtually (and auxetically) stretched. The encoding method is characterized by the fact of defining the 2D surface to have a spatially varying scale factor along at least a portion of the 2D surface, enabling spatial variation of the stretching capability of the 2D surface. Thanks to the spatially varying (or “spatially graded”) scale factor, the maximum possible expansion can be effectively controlled at each point, which in turn provides control over curvature: under maximal extension, non-uniform expansion forces the structure to buckle out of the plane and assume a curved configuration. The aim of the encoding method of the invention is to leverage this buckling behavior to design specific target 3D shapes. Given a desired target geometry, the method finds appropriate scaling parameters and a corresponding layout of the 2D linkage such that the target is reached under expansive deployment.

In one example of the present method, the geometric elements have all the same shape along the entire 2D surface. Alternatively, according to another example, the geometric elements may have different shapes, meaning that combinations of one or more differently shaped geometric elements can be implemented in the 2D surface. For instance, the 2D surface may comprise combinations of triangles and squares.

The geometric elements may have any suitable shape, as long as they can be used to establish an auxetic pattern on the 2D surface. Accordingly, the geometric elements can be regular polygons, such as squares, triangles, pentagons, hexagons, trapezoids, rhombi etc., concave polygons, such as crescents, circles, ellipses, star-shaped polygons, crosses, parallelograms, arrows, hearts, as well as any curvilinear modifications thereof, whenever applicable, such as quatrefoils or curvilinear triangles. The geometric elements may be linked between them through rotational joints. However, instead or additionally, the geometric elements can be linked through linearly displaceable elements or other connections. The geometric elements may each have at least one vertex, and be linked between them via their vertices. For instance, regular or curvilinear polygons having three vertices (as in the case of triangles), which are arranged to form an auxetic pattern, can be connected by rotational joints placed at or close to their vertices. Auxetic patterns according to the present invention may be obtained by disposing triangles in a Kagome lattice or by disposing squares in a snub square tiling lattice. The triangles or squares are thus linked among them by rotational joints placed at or close to their vertices. It is also possible to combine different types of lattices to obtain new lattices.

The present invention also relates to a method of manufacturing a deployable structure. The method comprises a step of encoding a curved 3D shape into a target 2D linkage according to the invention as described herein. As it will be apparent, a further object of the present invention relates to a deployable 3D structure obtainable by the method according to the invention as described herein, as well as to articles of manufacture comprising a deployable 3D structure obtained by the proposed method.

A deployable structure, as the name suggests, is a physical structure that can be deployed, unfolded or otherwise opened to reach a state in which the structure is ready for use. More generally, a deployable structure is a structure that can transition between two or more geometric configurations, thus changing its shape. Typically, deployable structures are unfolded by expansion by using a mechanical or electro-mechanical activation trigger, or simply by gravity or wind as in the case of a parachute for example. The deployable structures according to the invention are structured by a manufacturing process exploiting the encoding method as described herein: a starting planar surface is patterned by e.g. laser cutting, blading or by other suitable techniques known in the art according to the encoding method, in such a way that, upon deployment, the structure acquires a potential target 3D form encoded in the pattern itself. The starting structure has a substantially flat appearance, that is, its thickness is much smaller than the other dimensions (such as for instance one fifth of any other dimension), and can be made of any material allowing a deployment whenever needed. Suitable materials can be for instance plastic polymeric materials, composite materials, metallic materials or soft polymeric materials, such as rubbers or silicones, or any combination of the above materials. Full or empty geometric elements can be therefore patterned on the starting surface such that they span across the entire thickness of said surface, thus determining a spatially varying auxetic pattern thereon.

Depending on the needs and circumstances, the links, such as rotational joints, are located, or even patterned already during the manufacturing steps, in a way to allow the spatially-graded stretching of the geometrical elements according to the auxetic pattern designed on the 2D structure. For instance, in the case of triangles disposed in a Kagome lattice, the links can be advantageously located at the vertices of the triangles.

The deployable structures of the invention have several advantages: for instance, the reduced size in a rest state making packing and transportation easy in the case of bulky structures; the possibility to shape a freeform structure into a tailored, target one (as in the case of a fillable or inflatable balloon surrounded by a structure of the invention); the ability to easily conceive deployable structures having complex 3D shapes; the possibility to obtain structures, which do not have any scaffolding structures, and so forth. Particularly, according to one example, a deployable 3D structure of the invention has a doubly curved 3D shape, which may be devoid of any support structure. In this context, a “support structure” is a structure providing a shape to something else. Contrary to some existing solutions, in which deforming auxetic-patterned surfaces need an additional guide scaffolding to obtain a final, target shape, the structures of the present invention enable rapid deployment without guide surfaces by simple expansion, by spatially varying the pattern to uniquely encode the target shape, thus overcoming the limitations of the previous solutions. The deployment method of the present invention is also very robust, since the final state is precisely singled out by construction. The target is reached when the material cannot expand any further. The deployable 3D structure of the invention comprises geometric elements so that the 2D surface (and more specifically the 2D linkage) may be stretched by mechanical means or gravity loading. Alternatively, or in addition, the deployable 3D structure of the invention may be an inflatable structure. In this scenario, an inflatable, substantially flat structure, such as a mattress, is designed and manufactured by implementing the encoding method of the invention. Particularly, in one aspect, an inflatable deployable 3D structure of the invention may comprise a plurality of portions having a geometrical shape, the portions may or may not be inflatable, linked between them by a connecting inflatable net, the connecting net being designed according to the encoding method of the invention (i.e. forming an auxetic pattern): upon inflating, the net expands in the three dimensions to reach a target shape determined by the auxetic pattern.

Another aspect of the invention relates to an article of manufacture comprising a deployable 3D structure according to the invention as herein described. Such articles can be very diverse in nature thanks to the easy adaptation of the methods and structures of the present invention to several fields and applications: medical devices, such as coronary stents, pieces of furniture, architectural structures, such as relocatable domes, and car components are only some objects that can be produced by following the teachings of the present invention. Stents serve as an example of an application in personalized medicine, where a deployable freeform coronary stent can be customized to a specific patient. The stent is fabricated as a flat structure, then rolled into a thin cylinder. When inflated, the stent adopts the desired freeform shape to best advance blood flow in the critical artery. The articles may thus take various shapes, such as curved or straight tubular shapes (cylinders), spherical shapes, conical shapes, cubes etc.

Novel deployable structures that can approximate a large class of doubly-curved surfaces and are easily actuated from a flat initial state via inflation or gravitational loading are herein presented. The structures are based on 2D rigid mechanical linkages that implicitly encode the curvature of the target shape via a user-programmable pattern that permits locally isotropic scaling under load. In the embodiment described below, the shapes which are approximated have a positive mean curvature and bounded scale distortion relative to a given reference domain. Based on this observation, efficient computational design algorithms for approximating a given input geometry were developed. The resulting designs can be rapidly manufactured via digital fabrication technologies, such as laser cutting, computer numerical controlled (CNC) milling or 3D printing. This approach has been validated through a series of physical prototypes and demonstrated by several application case studies, ranging from surgical implants to large-scale deployable architectures.

In the example embodiment herein described, a planar linkage of rigid triangles connected by rotational joints at their vertices with regular connectivity, but having a spatially varying scale, has been put in place. In-plane rotation of the triangles induces an approximately isotropic expansion or contraction in area, which allows a mechanical interpretation of the linkage as an auxetic surface metamaterial, or a geometric interpretation in terms of conformal maps.

Several key challenges have been addressed by the inventors: for instance, determining which curvature functions can be encoded in such a pattern, how one can actuate a linkage to achieve maximal expansion, or which surfaces one can hope to realize using this procedure. To address these questions, the inventors introduced spatially graded auxetic metamaterials suitable for deployment via inflation or gravitational loading, for instance. In particular, it was shown that these deployment strategies achieve maximal expansion everywhere and provide additional regularization to ensure that the target shape is unique. Furthermore, a general analysis of deformation by inflation and gravitational loading was performed to formally classify the set of realizable doubly-curved target shapes. Finally, an optimization algorithm to solve the inverse design problem was proposed: given a desired target geometry, the method finds appropriate scaling parameters and a corresponding layout of the 2D linkage such that the target is reached under expansive deployment.

The developed deployable surface structures offer a number of benefits: (i) the rest state is (piece-wise) flat, which facilitates compact storage and enables the use of cost- and time-efficient fabrication technologies such as laser cutting or milling on a broad class of base materials; (ii) the target geometry is directly encoded in the 2D linkage structure so that no additional support or scaffold is required to guide the deployment; (iii) the approach is scale-invariant and can be applied to realize a broad and precisely defined class of doubly-curved surfaces. If a given design surface is not within the set of realizable shapes, an optimization process can be applied to find a feasible target surface that is close to the initial design.

### Shape Space

It is next contemplated which shapes it is possible to achieve with the proposed structures. The answer depends jointly on the geometry of the structure as well as the method used to actuate it. Rather than study this question in terms of the detailed geometry of a specific mechanical linkage, an idealized model based on smooth differential geometry is considered first. This analysis will then inform the design of discrete mechanical linkages, their physical actuation and the corresponding optimization algorithm as described later. In particular, the shapes one can hope to achieve via (i) inflation and (ii) gravitational loading will be explicitly characterized.

Let us consider a closed, compact, and oriented topological surface M with geometry given by a map f:M→ [symbol] ³ assigning coordinates to each point of M. The differential df of f maps tangent vectors X on M to the corresponding vectors df (X) in [symbol] ³; the differential is also sometimes denoted as the Jacobian or deformation gradient. A map f is an immersion if its differential is injective, i.e., if at each point p∈M it maps nonzero vectors to nonzero vectors; since M is compact, it is an embedding if f is also injective (loosely speaking: if it has no self-intersections). Formally, it will be required that f is a twice differentiable immersion with bounded curvature.

To any immersed surface it is possible to associate the quantity

vol(f):=∫_{M}N·fdA_{f},

where N is the outward unit normal and dA_{f} is the area element induced by f; when f is embedded, vol(f) is just the enclosed volume. g and H will also be used to denote the metric and mean curvature (resp.) induced by f. The definition H=½∇_{f}·N is used, so, e.g., a sphere has constant positive mean curvature. If dA and dÃ are two area measures on M, we will write dA≤dÃ to mean that dA(U)≤dÃ(U) for all measurable subsets U⊂M. When considering variations of the surface, f will be thought of as a time-parameterized family of immersions f(t), and adopt the shorthand

$${\dot{φ} := \frac{d}{dt} φ \vert}_{t = 0} = 0$$

for any time-varying quantity ϕ.

To understand the space of shapes that can be achieved via inflation, let us consider an idealized and purely geometric model of rubber balloons. From a mechanical viewpoint, our model would correspond (very roughly) to a thin isotropic elastic membrane with spatially varying maximum expansion. This model should however be taken with a grain of salt: the goal here is not to formulate a precise mechanical model, but rather to get a sense of the most significant geometric effects exhibited by our discrete mechanism. A more rigorous analysis (e.g., based on homogenization of the small-scale geometry) is beyond the scope of the present description. Moreover, for computational design, it is often more useful to have a simple and easily computable geometric model than a detailed mechanical model that is accurate but hard to explore due to heavy computational requirements (e.g., finite element analysis).

We specifically consider the geometry of immersions that (i) locally maximize enclosed volume, and (ii) do not stretch area above a given upper bound. Questions of dynamics (e.g., “can this configuration be reached from a given starting point?”), which are notoriously difficult even without constraints on volume or area, are not considered here. Instead, we consider only the simple static question of, “what will be true about a surface that achieves these conditions?” In particular, the following observation is made:

Proposition 1. Let dA⁺ be an area measure on M. Among all (twice differentiable) immersions f:M→ [symbol] ³ such that dA_{f}≤dA⁺, those that locally maximize the enclosed volume vol(f) will (i) have strictly positive mean curvature H>0 away from sets of measure zero, where H≥0; and (ii) will achieve the upper bound on area (dA_{f}=dA⁺).

Proof. (i) Suppose an immersion f admits a nonempty open set D⊆M on which H≤0. Then we can construct a smooth positive function u:M→ [symbol] supported on D and consider the outward normal variation \dot{f}:=uN. The corresponding first-order changes in volume and area measure are given by

$${\frac{d}{dt} vol ( f ) ρ {\vert}_{t = 0} = {\int }_{M} {udA}_{f} > 0 and \\ \frac{d}{dt} {dA}_{f} \vert}_{t = 0} = 2 {uHdA}_{f} ,$$

respectively. Since uH≤0, this variation increases volume without increasing area; hence, f is not a volume maximizing immersion. Moreover, if H<0 at any point p∈M, then (by continuity of H) there must be an open ball around p on which H is strictly negative. Hence, on sets of measure zero, an immersion f that maximizes volume must have H≥0.

(ii) Since both dA_{f} and dA⁺ are area measures, we have dA⁺=φdA_{f} for some continuous function φ:M→ [symbol] . If dA_{f}<dA⁺, then there will be at least one point p∈M where φ(p)<1, and by continuity, an open neighborhood D around p where φ<1. Letting u be a smooth positive function supported on D, a normal variation uN will now increase the volume without violating the area bound.

Generally speaking, the surfaces that can be realized via inflation in the present model are those that have positive mean curvature (see Proposition 1 and Section “Material design” for further discussion). In practice, it is proposed to modify a given target surface to have positive mean curvature, as described later.

According to the teachings of the present invention, it is possible to deploy a doubly-curved freeform surface from a single flat sheet of material. The expansive forces for deployment may be created by a generic rubber balloon that is inflated against a support plane. As the balloon is pumped with air, it presses against and deforms the linkage until the target shape is reached at maximal stretch. The balloon has no information about the target shape, which is solely encoded in the linkage pattern computed by the proposed algorithm. Note that while the inflated surface has advantageously positive mean curvature everywhere, both positive and negative Gaussian curvature are present in the target 3D shape.

Gravity is an even simpler mechanism for shape deployment: just suspend a sheet of material by its boundary and let gravity pull it into the target shape. This approach is most suitable for surfaces with simple boundary curves. In fact, to simplify the fabrication process, the initial surface spanning the boundary curves is advantageously a height field; otherwise attaching the flat material to the boundary curves would require a complicated manual deformation. The height field property also guarantees that the downward gravitational force has a positive component along the surface's normal direction, ensuring that it can pull the surface open analogously to the inflation setup.

When fabricated from our idealized material (characterized by having zero stiffness until an upper area bound is reached), it is observed that height-field-initialized surfaces will remain height fields during the deployment. This follows from the fact that only two types of forces act on interior points during the deployment: gravity and the material stresses enforcing the area bound. Gravity pushes points in the material straight downward, decreasing height values but preserving the height field property. Stresses enforcing the area stretch bound always take the form of tensile forces: regions of material that have reached their stretching bound pull uniformly inward against the surrounding material (tangentially to the surface). Unlike expansive forces, these tensile forces act to straighten out the material and will not cause the sheet to fold over itself to violate the height field property.

The space of height field surfaces deployable by gravity is now characterized, again ignoring questions of dynamics. For consistency with the inflation setup, the surface's height axis is oriented vertically (parallel to gravity) and the surface orientation is chosen so that normals point downward. The gravitational deployment process is formulated as minimizing the immersion f's gravitational potential energy:

U(f):=∫_{M}f·zdA,

where z is the height axis vector oriented opposite gravity and scaled by the gravitational acceleration constant. Note that dA is the area element induced by an isometric immersion of M (for which the material density is assumed to be 1) and is independent of the particular immersion f.

Proposition 2. A height field surface represented as a smooth immersion f:M→ [symbol] ³ that locally minimizes the gravitational potential energy U(f) over all smooth immersions satisfying dA_{f}≤dA⁺ and Dirichlet conditions f=f_{tgt} on ∂M, must (i) have strictly positive mean curvature H>0 away from sets of measure zero, where H≥0; and (ii) achieve the upper bound on area (dA_{f}=dA⁺).

Proof. (i) Suppose there exists a region D⊆M of nonzero measure on which H≤0. We can construct a smooth, positive bump function u compactly supported on D so that the positive normal variation \dot{f}:=uN decreases gravitational potential to first order:

$${\frac{d}{dt} U ( f + tuN ) \vert}_{t = 0} = {\int }_{D} uN \cdot zdA < 0 ,$$

because N·z<0 by the height field property. Furthermore, this variation does not violate the upper bound on area: the area measure changes by

d\dot{A}_{f}=2uHdAf≤0.

Therefore, f does not locally minimize gravitational potential energy. (The proof of part (ii) is analogous to Proposition 1).

If the surface violates the positive mean curvature requirement, according to the present embodiment, it is modified for compatibility with the proposed deployment mechanisms. Although other deployment mechanisms may be used instead. It is desirable to keep the modified design as similar to the input surface as possible. Accordingly, the surface is changed only where needed, leaving the regions of positive mean curvature untouched. In the regions violating the requirement, the smallest change necessary is made in mean curvature space.

The following repair process is proposed to achieve these goals: apply mean curvature flow \dot{f}=−HN to each region of negative mean curvature, terminating when mean curvature reaches zero. Then, to ensure H≥ε>0, an arbitrarily small, smooth normal variation can be applied, computed, e.g., by solving Equation 1 below with \dot{H}=1 and zero Dirichlet boundary conditions.

The proposed repair process indeed produces the closest admissible surface in the sense of minimizing pointwise curvature distance |H−H₀| almost everywhere in M (where H₀ is the mean curvature of the initial immersion): it preserves mean curvature in the positive regions and minimally adjusts each non-positive value. Curvature-based distance metrics like this are often considered good models of perceptual distance. However, for some examples, an additional observation can be made: the repair process also locally minimizes pointwise distances to the original surface.

The repair process can be formalized as follows. For a smooth initial immersion f₀:M→ [symbol] ³, the regions Rᵢ⊂M on which H<0 are always bounded by well-defined curves ∂Rᵢ. The repair process cuts away each f₀(Rᵢ) and replaces it with a minimal surface f(Rᵢ) spanning the same immersed boundary curve. This viewpoint corresponds to the limit ε→0.

First, we consider the space of admissible variations one might apply to the repaired surface when attempting to move it closer to the original. We consider an arbitrary suitably regular variation \dot{f}:=Rᵢ→ [symbol] ³ and define normal velocity u:=\dot{f}·N for convenience. We observe that u=0 on ∂Rᵢ since the perturbed surface must still fill the same boundary curve.

The corresponding first-order change in mean curvature is (Günay Doğan and Ricardo H. Nochetto, ESAIM: Mathematical Modelling and Numerical Analysis 46, 1 (2012), 59-79)

2\dot{H}=−Δ_{f}u−(k₁²+k₂²)u+2\dot{f}·∇_{f}H=−Δ_{f}u−2|K|u, (1)

where k₁=−k₂ are the minimal surface patch's principal curvatures. The term involving \dot{f} vanishes because H≡0, and we applied the simplification k₁²+k₂²=2|k₁k₂|=2|K|. Preserving non-negative mean curvature requires:

\dot{H}≥0⇒Δ_{f}u+2|K|u≤0.

For small |K| (mildly curved repaired patches), the Laplacian term is expected to dominate and force the normal velocity to achieve its minimum on the boundary ∂Rᵢ (superharmonic functions obey a minimum principle). But u=0 there, forcing u≥0 inside Rᵢ.

Furthermore, experimentally, closest points on the original surface always lie to the negative side of the repaired patch in that, ∀p∈f(Rᵢ) and nearest original points

$${p}^{*} = {argmin}_{\tilde{p} ∈ {f}_{0 ( {R}_{i} )}} ‖ \tilde{p} - p ‖ ,$$

we have N·(p*−p)≤0. This should be expected for moderate edits, as the curvature flow process converging to the minimal surface moves points only in the positive normal direction. In these cases, moving any point on the repaired surface closer to the original surface requires a motion in the negative normal direction which, for small |K|, violates the non-negative mean curvature constraint.

### Material Design

The goal is to design a mechanism that deforms from an initial flat configuration into a doubly-curved target surface when actuated by inflation or gravity, for example. These goals are achieved according to the present embodiment by (i) encoding the target shape into the linkage by considering a spatially varying pattern rather than a regular one, and by (ii) considering geometries that can be rapidly deployed via inflation or gravity, as studied in Section “Shape space”. Thus, the present solution does not necessitate any kind of “scaffolding”, such as a 3D print, to guide assembly. Furthermore, the surface does not need to be laboriously pointwise-aligned to the mold and deformed by hand.

The present embodiment is based on a Kagome lattice (in a fully expanded state). A key motivation for starting with the Kagome lattice is that, as observed by Mina Konaković et al. (“Beyond Developable: Computational Design and Fabrication with Auxetic Materials”, ACM Trans. Graph. 35, 4, Article 89 (July 2016), 11 pages), deformations of this lattice behave at the large scale like conformal mappings with bounded scale factor. This loose analogy is made a bit more precise by making a connection to the Cauchy-Riemann equations: for both conformal maps and the lattice, infinitesimal planar motions are determined by real degrees of freedom at the boundary. Another connection recently made in the literature is that infinitesimal rotations of the lattice can be described as discrete harmonic functions (in the usual sense of the cotangent Laplacian), mirroring the fact that for the logarithmic derivative log(w′)=uιθ of a holomorphic map w, the two components u, θ describing scaling and rotation (resp.) are conjugate harmonic. To date, however, there is still no complete discrete theory of conformal maps based on the Kagome lattice that includes finite deformations, nor conformal immersions in [symbol] ³. Nonetheless, adopting the conformal point of view allows us to leverage well-developed tools from computational conformal geometry for the purpose of designing deployable mechanisms.

From a mechanical point of view, linkages based on the Kagome lattice are flexible enough to produce a wide variety of curved surfaces and already have a locking mechanism built-in: stretching the material to four times its original area fully opens the linkage, blocking further expansion. In fact, one can easily show that the linkage is rigid (albeit unstable) in its fully open configuration; additional forces such as gravity or air pressure help to stabilize the fully open state. Advantage is taken of these mechanical properties to aid deployment. In particular, we adapt the pattern to achieve a spatially varying (rather than constant) maximum bound on expansion across the surface. When deployed, the varying expansion leads to out-of-plane buckling; thus the linkage must assume a curved configuration.

The geometric and mechanical pictures can of course be linked: the bound on expansion in the discrete linkage can be modeled by a bound on the conformal scale factor e^{u} of a smooth conformal map, and the buckling exhibited by the deployed linkage is approximately determined by the Yamabe equation Δu=−e^{2u}K relating the logarithm of the scale factor to the Gaussian curvature K of a smooth surface approximating the target geometry. To explore designs for our mechanical linkage, we therefore adopt a strategy based on geometry: first, we compute a conformal map from the plane to the target surface, and read off the scale factors λ_{tgt}:=e^{u}. We then use these factors to design or “program” a spatially-graded pattern that approximately matches the corresponding maximum expansion at each point. When fully expanded, a mechanism based on this pattern should approximate the desired target shape. Below we first consider the uniqueness of the deployed configuration, before detailing how to program the desired maximal expansion factor into the discrete triangular linkage of the present embodiment.

The spatially varying maximal extension factor uniquely determines the fully expanded linkage's metric. In other words, the deployed shape is completely determined up to isometric deformation. Does this mean that the metamaterial uniquely encodes the target shape? In general, the answer is no. For instance, the material alone cannot distinguish between “bumps” with negative or positive mean curvature since both produce the same metric distortion. However, in this case the specific deployment methods provide additional regularization: they always produce surfaces of positive mean curvature, eliminating this ambiguity.

Convex surfaces are known to be unique up to global rigid transformations. Surprisingly, the question of whether smooth closed surfaces can be flexible in [symbol] ³ (i.e., admit infinitesimal deformations preserving the metric) remains an open problem in differential geometry. So far, no examples have been found, and in practice, all of tested examples deployed to their proper target configurations.

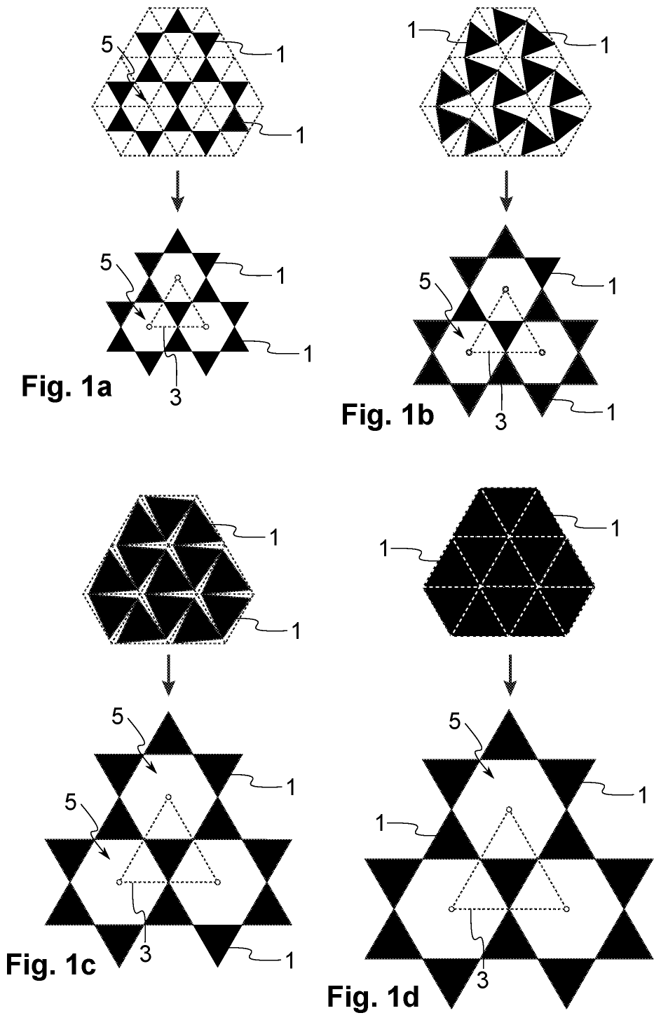

We now consider how to adapt the regular triangle auxetic linkage structure to impose a spatially varying upper scaling bound tailored to the conformal scale factor λ_{tgt}. We begin with the following observation: taking the standard linkage pattern (with length stretch factor λ in the range 1≤λ≤2) and pre-stretching by 2/λ_{tgt} yields a new material with the stretching bounds λ_{tgt}/2≤λ≤λ_{tgt}. Effectively, this pre-stretching limits the amount of additional expansion possible until the fully opened configuration is reached as illustrated in FIGS. 1a to 1d. This reduces our problem to producing a linkage with a spatially-varying pre-stretch in its flat configuration. The challenge now is to piece together patches with different pre-stretch. As illustrated in FIGS. 1a to 1d, this can only be done by scaling the triangles 1, as will be detailed below. The configurations of FIGS. 1a to 1d illustrate how spatially variable maximal expansion of the linkage can be achieved by scaling and rotating the linkage triangles in the initial 2D state (upper drawings in FIGS. 1a to 1d). The lower drawings show the linkage in its final (or deployed state). When already fully opened in the initial state as shown in FIG. 1a, no more expansion is possible. When the initial state is fully closed as shown in FIG. 1d, the linkage can expand to increase by a factor of two in length (or a factor of four in area). Partially opening the initial configuration allows varying the scale factor, indicated by the size of the triangles 3 with dashed outlines connecting the barycenters of the openings (hexagons) 5.

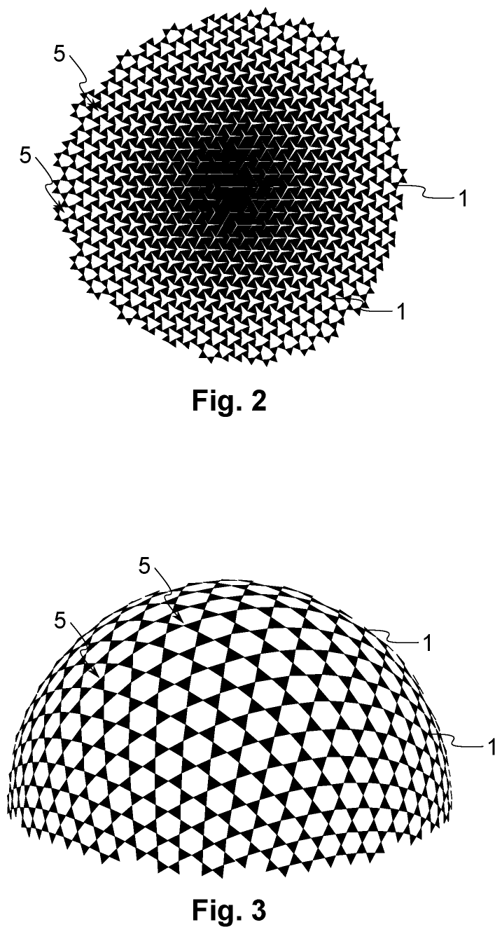

FIG. 2 shows a 2D pattern according to an example of the present invention, while FIG. 3 shows the same pattern but in the deployed state. It is to be noted that the nonuniform linkage structure no longer fully opens or closes in the plane as opposed to the regular auxetic linkage. The proposed spatially varying initial openings in the 2D state allow encoding the target surface in the flat configuration, facilitating automatic deployment by maximal expansion without the need of any guide surface. Once any region (hexagonal opening) in the pattern fully opens or fully closes, further expansion/contraction requires spatially varying the stretch factors, inducing curvature that forces the structure into 3D. It is to be noted that according to known solutions, the structure of FIG. 2 would be a homogeneous pattern (e.g. uniform, fully closed), while the target 3D state would be achieved with variable partial openings. Proper deployment thus requires a guide surface and precise manual alignment.

### Material Optimization

In this section, the computational workflow and the optimization algorithm for computing the deployable auxetic linkage for a given design surface are explained in more detail.

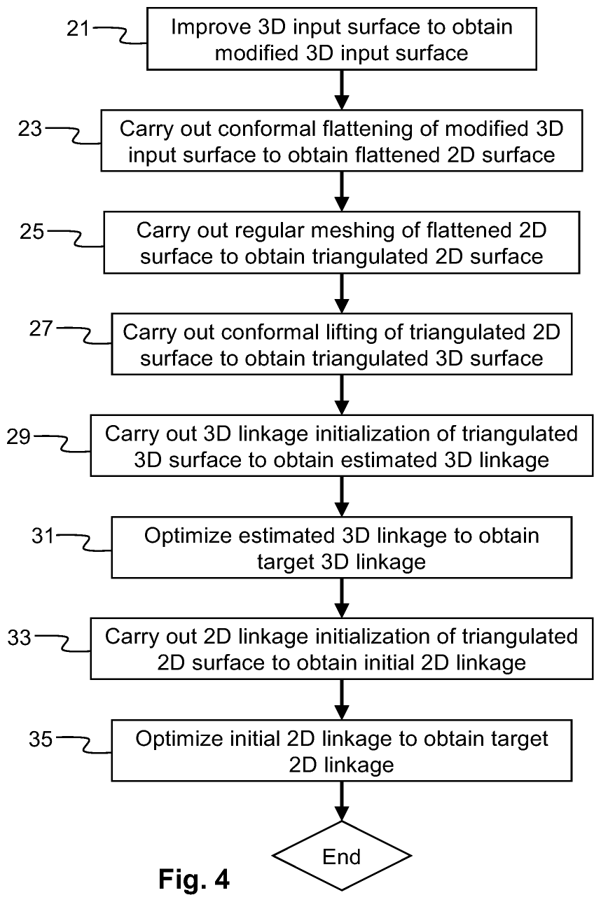

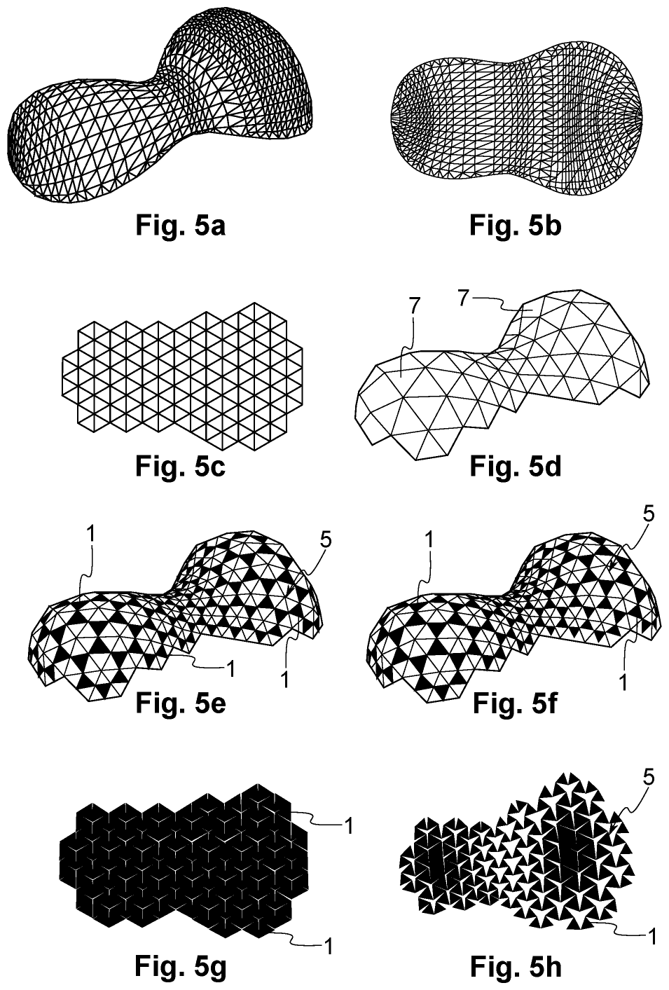

The proposed method is next explained with reference to the flow chart of FIG. 4 and FIGS. 5a to 5h. In step 21, the input or target surface is analyzed to ensure that it satisfies the positive mean curvature requirement. As discussed earlier, infeasible surfaces are corrected by applying mean curvature flow adapted to operate only on regions of non-positive mean curvature. We use implicit integration for the flow as proposed by Mathieu Desbrun et al. (“Implicit Fairing of Irregular Meshes Using Diffusion and Curvature Flow” In Proceedings of the 26th Annual Conference on Computer Graphics and Interactive Techniques (SIGGRAPH '99), ACM Press/Addison-Wesley Publishing Co., New York, N.Y., USA, 317s-324), running the flow until convergence updating only the positions of vertices with non-positive mean curvature. Given the corrected or modified input surface S as shown in FIG. 5a, the goal now is to find the 2D layout of the triangular linkage that, when deployed to maximal expansion, approximates S as closely as possible.

In step 23, a conformal map f:S→Ω is computed from the input surface S to a planar domain Ω⊂ [symbol] ² using the methods of Rohan Sawhney and Keenan Crane (“Boundary First Flattening”, ACM Trans. Graph. 37, 1, Article 5 (December 2017), 14 pages), for example. It is checked if the conformal scale factors are within the bounds prescribed by the linkage mechanism, and, if necessary, cone singularities are introduced at user-selected locations to reduce scale distortion as described below. FIG. 5b shows the result of step 23. In step 25, the parametric domain Ω is sampled with a given mesh, which in this example is a regular equilateral triangle mesh M_{2D} that defines the base structure of our linkage. In other words, in this example, a triangulation of the 2D surface of FIG. 5b is carried out. The user selects the resolution and orientation of this mesh to match their design intent. FIG. 5c shows the result of step 25. The triangles 1 of FIG. 5c have all the same size. In step 27, the 2D mesh M_{2D} is virtually lifted onto S by the inverse map f⁻¹ yielding a 3D mesh or map M_{3D}. FIG. 5d illustrates the outcome of step 27. The triangles 1 of M_{3D} no longer are of the same size.

In step 29, an initial guess is obtained for the fully-opened linkage structure by constructing the medial triangle or midpoint triangle for each surface element 7 (which in this example are triangles) in M_{3D} (i.e., inscribing a triangle by connecting edge midpoints). The result is shown in FIG. 5e. The medial triangle is formed by connecting the midpoints of the surface elements' sides. While this initialization is already close to the desired target configuration, the discrete nature of the lifting function introduces inaccuracies that may necessitate further optimization. In particular, in this example, it must be ensured that the linkage triangles remain equilateral and are maximally expanded everywhere while staying close to the target surface. The 3D linkage optimization is carried out in step 31. Fortunately, these objectives can be formulated easily in the context of the projective approach of Sofien Bouaziz et al. (“Shape-Up: Shaping Discrete Geometry with Projections”, Comput. Graph. Forum 31, 5 (2012), 1657-1667). Specifically, to obtain the linkage's curved target configuration L_{3D} we minimize an energy function E_{L3D} defined as the sum of three different objective terms over the vertex positions x,

E_{L3D}(x)=ω₁E_{expand}(x)+ω₂E_{equi}(x)+ω₃E_{design}(x),

with weights ωᵢ. The weight may be selected so that ω₁=ω₂ for example, while ω₁ or ω₂ could equal 100×ω₃. Each term can be formulated as a sum of constraint proximity functions of the form ϕ(x_{c})=∥x_{c}−P(x_{c})∥₂², where x_{c} is the vertex set involved in the specific constraint, and P denotes the projection operator to the constraint set, as detailed below.

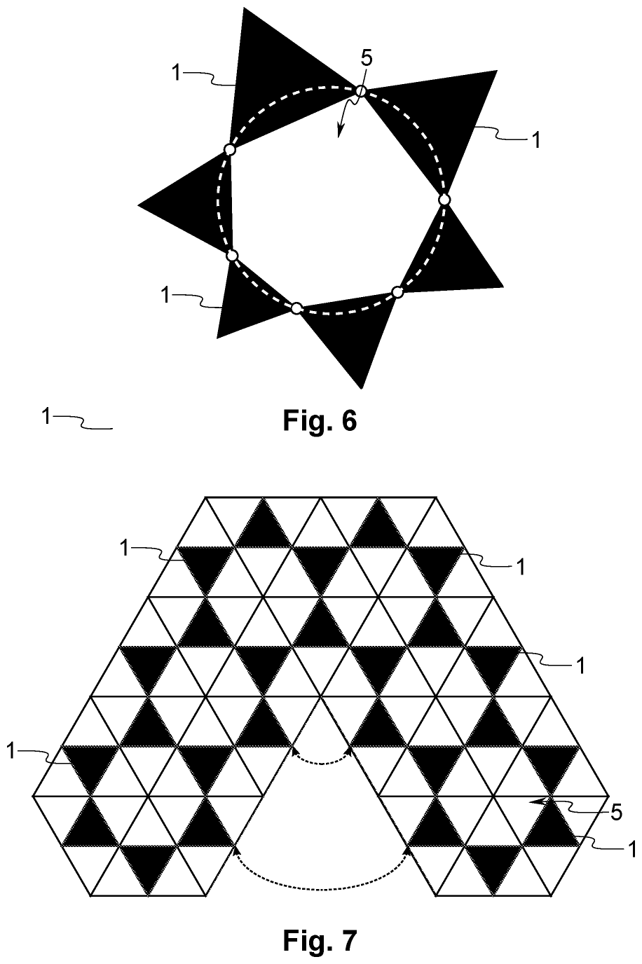

We observe that in the fully expanded state, the hexagonal openings formed by the linkage must attain maximum area. By Cramer's theorem (I. Niven, 1981, “Maxima and Minima Without Calculus” Number v. 6 in Dolciani Mathematical Expositions, Mathematical Association of America), this maximum is achieved when all vertices of the opening lie on a circle as shown in FIG. 6.

We thus introduce the expansion term

$${E}_{expand} = {\sum }_{h ∈ C}^{ } {‖ {x}_{h} - {P}_{C} ( {x}_{h} ) ‖}_{2}^{2} ,$$

where h is an index set of vertices in a particular hexagonal opening (i.e. six vertices per set in this example), and C is the collection of all such index sets in the linkage. P_{C}(xₕ) defines the projection to the circle closest to the vertices of xₕ computed as described by Sofien Bouaziz et al. (“Shape-Up: Shaping Discrete Geometry with Projections”, Comput. Graph. Forum 31, 5 (2012), 1657-1667).

Contrary to the uniform pattern used in known solutions, the linkage triangles according to the present embodiment vary in scale to introduce spatially varying maximal expansion. In order to let the triangles scale freely but keep their equilateral shape, we introduce the energy

$${E}_{equi} = {\sum }_{t ∈ T}^{ } {‖ {x}_{t} - {P}_{T} ( {x}_{t} ) ‖}_{2}^{2} ,$$

where t is the index set of the vertices of a triangle (i.e. three vertices per set in this example), T is the set of all linkage triangles, and P_{T} is the projection to the closest equilateral triangle, computed using shape matching as described by Shinji Umeyama (“Least-Squares Estimation of Transformation Parameters Between Two Point Patterns”, IEEE Trans. Pattern Anal. Mach. Intell. 13, 4 (1991), 376-380).

Finally, to keep the linkage close to the input or modified input surface, we apply positional constraints of the form

$${E}_{design} = {\sum }_{v ∈ V}^{ } {‖ {x}_{v} - {P}_{S} ( {x}_{v} ) ‖}_{2}^{2} ,$$

where v is a vertex index, V is the set of all linkage vertices (thus including the vertices of all the triangles and hexagons in a given linkage, for example), and P_{S} defines the projection to the closest point on S.

The minimization of E_{L3D} then follows the typical local/global iteration strategy (see e.g. Olga Sorkine and Marc Alexa “As-rigid-as-possible Surface Modeling”, In Proceedings of the Fifth Eurographics Symposium on Geometry Processing (SGP '07), Eurographics Association, 109-116): the local step computes all the constraint projections involved in the objective terms for the fixed current vertex positions; the global step subsequently solves for the optimal vertex positions keeping the constraint projections fixed. Details on the precise definitions of the projection operators and the corresponding numerical solver implementations can be found for example in Sofien Bouaziz et al. (“Shape-Up: Shaping Discrete Geometry with Projections”, Comput. Graph. Forum 31, 5 (2012), 1657-1667). The 3D linkage L_{3D} resulting from step 31 is shown in FIG. 5f.

The 3D optimization provides us with the curved target configuration L_{3D} of the linkage in its fully opened state as shown in FIG. 5f. Now we need to find the contracted linkage in the plane that defines the material rest state to be fabricated. We formulate this problem as a second projective optimization. In step 33, first the necessary topological cuts are applied to convert the 2D mesh M_{2D} into a regular triangular linkage L_{2D} with uniform triangle sizes as shown in FIG. 5g. This flat linkage has a one-to-one vertex correspondence with the deployed linkage L_{3D}. Next in step 35, the 2D vertex coordinates u of L_{2D} are optimized so that the triangles assume the edge lengths of L_{3D}. This is implemented using a projective edge length constraint of the form

$${E}_{edge} = {\sum }_{( i , j ) ∈ E}^{ } {‖ ( {u}_{i} - {u}_{j} ) - {P}_{E} ( {u}_{i} , {u}_{j} ) ‖}_{2}^{2} ,$$

where (i, j) denotes the vertex indices of an edge and E is the set of edges of the linkage. The operator

$${P}_{E} ( {u}_{i} , {u}_{j} ) = \frac{‖ {x}_{i} - {x}_{j} ‖}{‖ {u}_{i} - {u}_{j} ‖} ( {u}_{i} - {u}_{j} )$$

projects to the closest edge with target length ∥xᵢ−xⱼ∥ of the corresponding edge in the 3D linkage L_{3D}. We also add the non-penetration constraint proposed by Mina Konaković et al. (“Beyond Developable: Computational Design and Fabrication with Auxetic Materials”, ACM Trans. Graph. 35, 4, Article 89 (July 2016), 11 pages) to avoid collisions in the 2D state. In other words, in this step the triangles of the 2D linkage of FIG. 5h are rotated and scaled based on the target 3D linkage L_{3D}, or more specifically based on the data extracted from that linkage. The final optimized linkage L_{2D} as shown in FIG. 5h then defines the flat auxetic surface material that deploys to the desired target state. It is to be noted that steps 33 and 35 may be carried out at least partly in parallel with steps 27 to 31.

When the conformal scale factors exceed the maximal expansion limits of the auxetic linkage, cone singularities are advantageously inserted in the conformal map to reduce scale distortion. Singularities can also be mandated by the input surface's topology (to satisfy the Gauss-Bonnet theorem). These singularities correspond to boundary vertices of M_{2D} where the incident boundary curves (seams) close up when lifted to M_{3D} by the conformal map.

Because conformal maps preserve angles, for the surface to close up and form a regular equilateral triangle mesh when lifted to M_{3D}, the sum of triangle angles around the singular vertex in M_{2D}, referred to as the cone angle, is an integer multiple of

$$\frac{π}{3} .$$

FIG. 7 shows an example with cone angle

$$\frac{5 π}{3} ,$$

and it can be understood how the equilateral triangle mesh (and an inscribed linkage) will properly stitch together when lifted to M_{3D}.

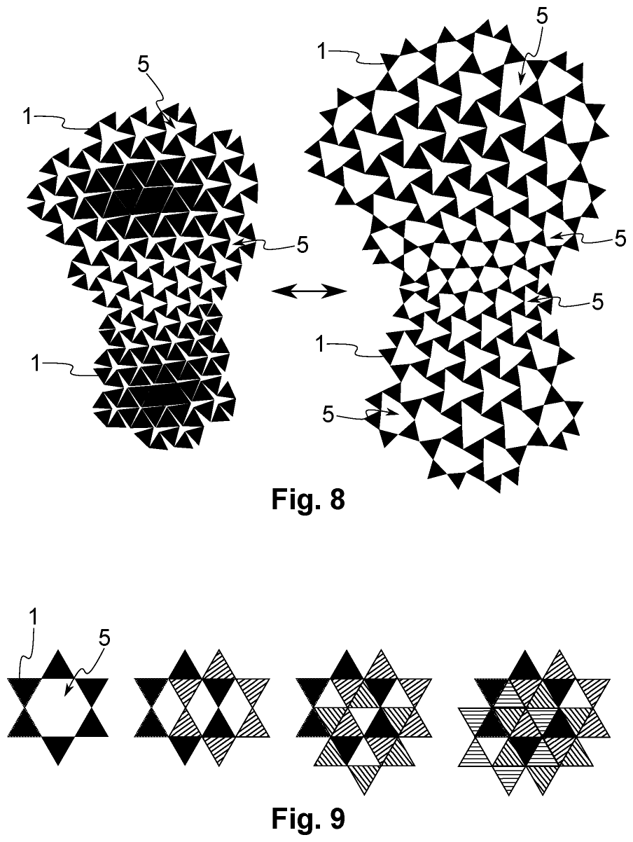

If the computed scale factors do not fully cover the maximal admissible range, the resulting 2D linkage can still be expanded in the plane until one hexagonal opening is fully opened or contracted until one opening is fully closed as shown in FIG. 8. This in-plane opening is leveraged for the fabrication process to reduce the material stresses at the triangle joints during inflation by pre-opening the linkage as much as possible. This minimizes the rotation necessary to achieve the fully expanded configuration. In the optimization, an additional angle constraint is added as described by Bailin Deng et al. “Interactive Design Exploration for Constrained Meshes”, Computer-Aided Design 61 (2015), 13-23) with a low weight that either tries to expand or contract the linkage in the flat configuration, depending on the user's preference.

If the user desires a deployed surface without holes, the hexagonal openings 5 in the fully expanded linkage can be filled in by layering a given number of sheets, in this example four sheets offset from each other as shown in FIG. 9. However, simply creating copies of the optimized linkage L_{3D} and shifting them would not be optimal. This would effectively translate the deployed surface itself and also would lead to triangles imperfectly fitting the hexagonal holes due to the varying scale factors. Instead, these sheets are designed by offsetting copies of M_{2D} in the parametric domain and lifting/optimizing them in 3D. FIG. 9 shows an example of a surface filled in with this method.

According to the proposed solution, the target geometry is implicitly encoded in the structure itself. It has been shown that spatially graded auxetics are well suited to implement deployable surface structures. Instead of rationalizing a 3D design surface for a given homogeneous material, the material itself is spatially optimized. By carefully controlling the expansion behavior of the material, the target surface geometry is directly programmed into the flat 2D rest state. Inflation or gravitational loading, for example, may then be used to automatically deploy the rest state towards the target, which is assumed when the material cannot expand any further. As a consequence, the efficiency of 2D digital fabrication technologies can be leveraged without requiring any additional 3D guide surface. The proposed deployment strategy is robust and reversible, which supports efficient storage and transport and enables new applications for semi-permanent structures.

While the invention has been illustrated and described in detail in the drawings and foregoing description, such illustration and description are to be considered illustrative or exemplary and not restrictive, the invention being not limited to the disclosed embodiment. Other embodiments and variants are understood and can be achieved by those skilled in the art when carrying out the claimed invention, based on a study of the drawings, the disclosure and the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method for encoding a 3D shape into a target 2D linkage, the method comprising:
obtaining an initial 2D surface based on the given 3D shape; and
defining on the initial 2D surface an auxetic pattern of geometric elements planarly linked between them to obtain the target 2D linkage, the pattern allowing the target 2D linkage to be virtually stretched to reach a 3D target linkage approximating the 3D shape; and
wherein the target 2D linkage has a spatially varying scale factor thereby spatially varying the stretching capability of the target 2D linkage.

2. The method according to claim 1, wherein the geometric elements have substantially the same shape.

3. The method according to claim 1, wherein the geometric elements are linked between them by rotational joints.

4. The method according to claim 1, wherein the geometric elements comprise at least one vertex, and wherein the geometric elements are linked between them by their vertices.

5. The method according to claim 1, wherein the geometric elements are triangles arranged in a Kagome lattice in the target 3D linkage or squares arranged in a snub square tiling lattice in the target 3D linkage.

6. The method according to claim 1, wherein the 3D shape is a singly or doubly curved 3D shape.

7. The method according to claim 1, wherein the method further comprises optimizing the 3D shape by removing negative mean curvatures from the 3D shape prior to obtaining the initial 2D surface.

8. The method according to claim 1, wherein the initial 2D surface is obtained by conformally flattening the 3D shape or its optimized 3D shape.

9. The method according to claim 1, wherein the method further comprises sampling the initial 2D surface with a given mesh to obtain a sampled 2D surface.

10. The method according to claim 9, wherein the method further comprises virtually lifting the sampled 2D surface to obtain a sampled 3D surface.

11. The method according to claim 10, wherein the method further comprises carrying out a 3D linkage initialization of the sampled 3D surface to obtain an initial 3D linkage comprising a set of the geometric elements of unequal size separated by openings.

12. The method according to claim 11, wherein the 3D linkage initialization is carried out by connecting middle points of respective surface elements of the sampled 3D surface to form the geometric elements of the initial 3D linkage.

13. The method according to claim 12, wherein the method further comprises optimizing the initial 3D linkage to obtain the target 3D linkage.

14. The method according to claim 9, wherein the method further comprises carrying out a 2D linkage initialization of the sampled 2D surface to obtain an initial 2D linkage comprising a set of the geometric elements of equal size separated by cuts.

15. The method according to claim 14, wherein the method further comprises optimizing the initial 2D linkage based on information from the target 3D linkage to obtain the target 2D linkage.

16. The method according to claim 1, wherein the method further comprises virtually lifting the target 2D linkage to the 3D target linkage, and wherein the lifting comprises fully expanding the 2D linkage to obtain the target 3D linkage.

17. A deployable 3D structure obtainable by the method of claim 1.

18. The deployable 3D structure according to claim 17, wherein the geometric elements are arranged to be stretched by at least one of the following means: inflation, mechanical means and gravity.

19. The deployable 3D structure according to claim 17, wherein the deployable 3D structure is devoid of a support or guide structure.

20. A data processing unit for carrying out a method of encoding a 3D shape into a target 2D linkage, the data processing unit being configured to:
obtain an initial 2D surface based on the 3D shape; and
define on the initial 2D surface an auxetic pattern of geometric elements planarly linked between them to obtain the target 2D linkage, the pattern allowing the target 2D linkage to be virtually stretched to reach a 3D target linkage approximating the 3D shape; and
wherein the target 2D linkage has a spatially varying scale factor thereby spatially varying the stretching capability of the target 2D linkage.
